(19) United States
(12) Patent Application Publication
(10) Pub. No.: US 2015/0267816 A1
(43) Pub. Date: Sep. 24, 2015

(54) ROTARY SHAFT SEAL

(71) Applicant: Saint-Gobain Performance Plastics Corporation, Aurora, OH (US)

(72) Inventor: Mario Boskovski, Duesseldorf (DE)

(21) Appl. No.: 14/664,642

(22) Filed: Mar. 20, 2015

Related U.S. Application Data
(60) Provisional application No. 61/968,434, filed on Mar. 21, 2014.

(51) Int. Cl. F16J 15/32

(52) U.S. Cl. CPC F16J 15/3208; F16J 15/3284

(57) ABSTRACT

A rotary shaft seal including an annular body having an aperture defining a central axis and an inner surface; a sealing element positioned at least partially within the annular body, wherein the sealing element is configured to extend radially and form a seal between the annular body and a shaft disposed within the aperture of the annular body; and a biasing element biasing at least a portion of the sealing element in a radial direction.

### CROSS-REFERENCE TO RELATED APPLICATION(S)

This application claims priority under 35 U.S.C. §119(e) to U.S. Patent Application No. 61/968,434 entitled “ROTARY SHAFT SEAL,” by Mario Boskovski, filed Mar. 21, 2014, which is assigned to the current assignee hereof and incorporated herein by reference in its entirety.

### FIELD OF THE DISCLOSURE

The present disclosure relates to shaft seals, and more particularly to shaft seals having a biasing element.

### RELATED ART

A rotary, or reciprocating, machine can feature an enclosed internal mechanism that drives a shaft. In some cases, the shaft can pass through the housing of the machine on one or both ends. In such cases, a rotary shaft seal, sometimes referred to as a lip seal, can be disposed near an exit point to retain a lubricating fluid, such as oil or grease, in the housing as well as prevent ingress of contaminants, such as moisture and dust. The rotary shaft seal can have an outer diameter that provides a seal against the housing, and a sealing lip that provides a seal against the shaft. The sealing lip should exert a radial load on the shaft that provides sufficient sealing properties without excessive friction or wear.

There continues to exist a need for a rotary shaft seal having improved sealing properties.

### BRIEF DESCRIPTION OF THE DRAWINGS

Embodiments are illustrated by way of example and are not limited in the accompanying figures.

FIG. 1 includes a cross section plan view of a seal in accordance with an embodiment.

FIG. 2 includes a cross section plan view of a seal in accordance with an embodiment.

FIG. 3 includes a perspective view of a biasing element in accordance with an embodiment.

FIG. 4 includes a perspective view of a biasing element in accordance with an embodiment.

FIG. 5A includes a cross-sectional plan view of a seal in accordance with an embodiment.

FIG. 5B includes a perspective cross-sectional view of a seal in accordance with an embodiment.

FIG. 6A includes a cross-sectional plan view of a seal in accordance with an embodiment.

FIG. 6B includes a perspective view of a seal in accordance with an embodiment.

FIG. 7A includes a cross-sectional plan view of a seal in accordance with an embodiment.

FIG. 7B includes a perspective view of a seal in accordance with an embodiment.

FIG. 8 includes a cross section plan view of a seal engaged with a shaft in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the shaft seal arts.

In a first aspect, a shaft seal can generally include a body, i.e., an annular body, a sealing element disposed within the body, and a biasing element adapted to bias the sealing element against a rotating shaft.

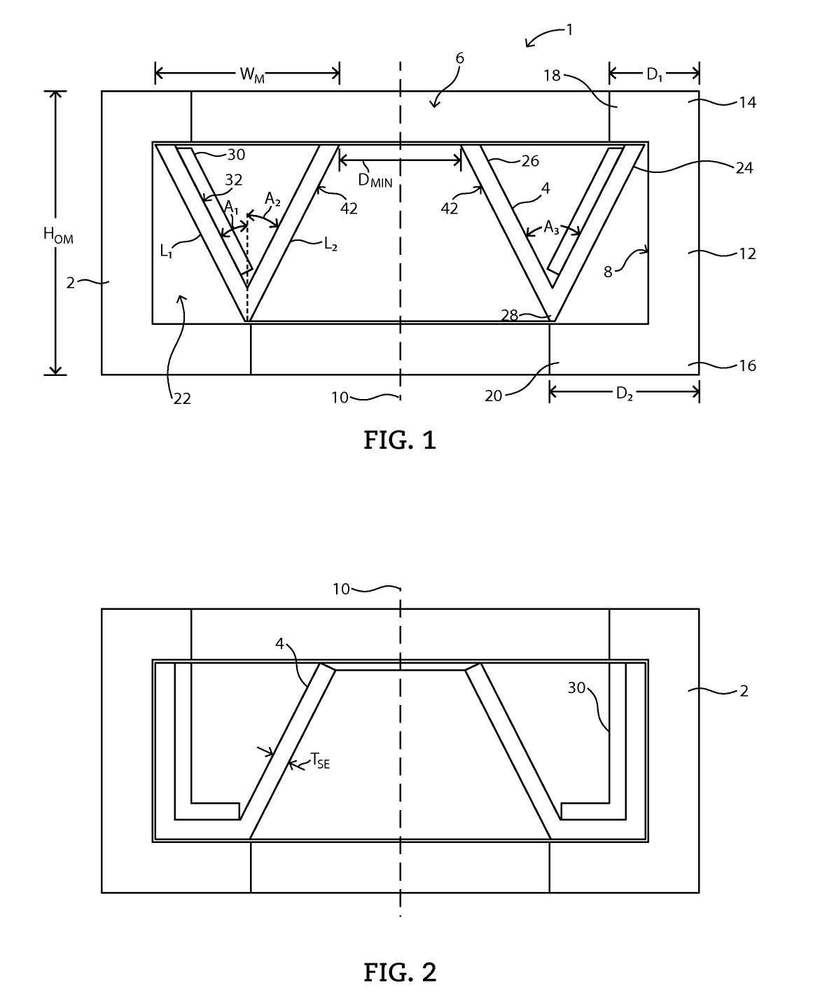

Referring initially to FIG. 1, a seal 1 can generally include an annular body 2 and a sealing element 4 positioned at least partially within the annular body 2.

The annular body 2 can comprise a material having a Brinell hardness (HB) in a range between and including about 70 to about 150, such as in a range between about 75 to about 145, in a range between about 80 to about 140, in a range between about 85 to about 135, in a range between about 90 to about 130, in a range between about 95 to about 125, in a range between about 100 to about 120, or even in a range between about 105 to about 115.

In a particular aspect, the annular body 2 can comprise a material having an ultimate tensile strength of at least about 350 megapascal (MPa), such as at least about 360 MPa, at least about 370 MPa, at least about 380 MPa, at least about 390 MPa, at least about 400 MPa, or even at least about 410 MPa. In further embodiments, the annular body 2 can comprise a material having an ultimate tensile strength of no greater than about 5000 MPa, such as no greater than about 4000 MPa, no greater than about 2000 MPa, no greater than about 1000 MPa, or even no greater than about 500 MPa. Moreover, the annular body 2 can comprise a material having a tensile strength within a range between and including any of the values described above, such as, for example, between about 275 and about 355.

In another aspect, the annular body 2 can comprise a material having a Modulus of Elasticity (MOE) of between about 10 MPa and about 1000 MPa, such as between about 15 MPa and about 750 MPa, between about 20 MPa and about 500 MPa, between about 30 MPa and about 250 MPa, between about 45 MPa and about 200 MPa, between about 75 MPa and about 150 MPa, or even between about 90 MPa and about 130 MPa. In a more particular embodiment, the annular body 2 can comprise a material having an MOE of between about 100 MPa and about 125 MPa.

In a further aspect, the annular body 2 can comprise a material having a coefficient of thermal expansion (CTE) of between about 1×10⁻⁶ in/in° F. and about 75×10⁻⁶ in/in° F., such as between about 2×10⁻⁶ in/in° F. and about 50×10⁻⁶ in/in° F., between about 3×10⁻⁶ in/in° F. and about 25×10⁻⁶ in/in° F., between about 5×10⁻⁶ in/in° F. and about 15×10⁻⁶ in/in° F., or even between about 7×10⁻⁶ in/in° F. and about 11×10⁻⁶ in/in° F.

In yet a further aspect, the annular body 2 can comprise a material having an elongation at break (EAB) of no greater than about 60%, such as no greater than about 55%, no greater than about 50%, no greater than about 45%, no greater than about 40%, no greater than about 30%, no greater than about 20%, or even no greater than about 10%. In further embodiments, the annular body 2 can comprise a material having an EAB of no less than about 0.5%, such as no less than about 1%, no less than about 2%, or even no less than about 5%. Moreover, the annular body 2 can comprise a material having an EAB within a range between and including any of the values described above, such as, for example, between about 45% and about 55%.

In certain embodiments, the annular body 2 can comprise a metal. For example, in particular embodiments, the annular body 2 can comprise aluminum, bronze, copper, or lead.

In other embodiments, the annular body 2 can comprise an alloy. For example, in non-limiting embodiments, the annular body 2 can comprise a copper-zinc alloy, a copper-zinc-lead alloy, a copper-nickel-zinc alloy, a leaded copper, brass, bronze, iron, a ferroalloy, or even steel. The present disclosure is not intended to be limited in any way by the material of the annular body 2 as described in the above embodiments. For example, in yet other embodiments, the annular body 2 can comprise a polymer, such as, for example, ultra-high molecular weight polyurethane (UHMWPE), poly(vinyl chloride) (PVC), aliphatic polyamides, or even para-aramids such as Kevlar®.

The annular body 2 can be generally cylindrical and can further include an aperture 6 defining an inner surface 8 and a central axis 10. In a particular aspect, the aperture 6 can be coaxial, or substantially coaxial, with the central axis 10.

In certain embodiments, the annular body 2 can be formed from multiple components connected together. The multiple components may be engaged to form the annular body 2 by any method recognizable in the art, such as, for example, by melting, sintering, welding, threaded or nonthreaded engagement, or any combination thereof.

The annular body 2 can comprise a homogenous composition or may comprise two or more discrete portions having different compositions.

Moreover, in one non-limiting embodiment, although not applicable to all embodiments, the annular body 2 may not include a polymer, and more particularly, may be essentially free of any/all polymers. In a particular aspect, the annular body 2 may comprise a single material free of any coating or surface layer.

The annular body 2 can be untreated or treated to enhance the physical or chemical properties thereof. For example, in particular embodiments, the annular body 2 can be treated using techniques such as laser melting or ablation, mechanical sandblasting or chemical picking. In further embodiments, the annular body 2 can be treated by galvanizing, chromate or phosphate treatments, or anodizing.

In a particular aspect, the annular body 2 can have a generally C-shaped cross section when viewed in a direction perpendicular to a plane extending radially from the central axis 10. In another aspect, the annular body 2 can have any other shape when viewed in a direction perpendicular to a plane extending radially from the central axis 10, such as, for example, a generally I-shape, a generally J-shape, or even a generally L-shape.

In particular embodiments, the annular body 2 can define an outer member 12 having a first end 14 and a second end 16 opposite the first end 14. A first flange 18 can be disposed proximate the first end 14 of the outer member 12 and can extend radially inward therefrom. A second flange 20 can be disposed proximate the second end 16 of the outer member 12 and can extend radially inward therefrom.

The first and second flanges 18 and 20 can each extend a radial distance, D₁ and D₂, respectively, as measured from the innermost surface of the outer member 12.

In some embodiments, D₁ can be equal to D₂.

In other embodiments D₁ can be no less than D₂. For example, D₁/D₂ can be at least about 1.01, such as at least about 1.05, at least about 1.25, at least about 1.50, at least about 1.75, at least about 2.0, at least about 2.25, at least about 2.50, at least about 2.75, or even at least about 3.0. In further embodiments, D₁/D₂ can be no greater than about 6.0, such as no greater than about 5.0, no greater than about 4.0, or even no greater than about 3.5. Moreover, D₁/D₂ can be within a range between and including any of the values described above, such as, for example, between about 2.0 and about 2.75.

The outer member 12 can have a height, H_{OM}, as measured by a distance between the first and second ends 14 and 16. In particular embodiments, H_{OM}/D₂ can be at least about 0.5, such as at least about 0.75, at least about 1.0, at least about 1.25, at least about 1.5, or even at least about 2.0. In further embodiments, H_{OM}/D₂ can be no greater than about 8.0, such as no greater than about 7.0, no greater than about 6.0, no greater than about 5.0, no greater than about 4.0, or even no greater than about 3.0. Moreover, H_{OM}/D₂ can be within a range between and including any of the values described above, such as, for example, between about 1.75 and about 2.25.

In certain embodiments, H_{OM}/D₁ can be at least about 0.75, such as at least about 1.0, at least about 1.25, at least about 1.5, or even at least about 2.0. In further embodiments, H_{OM}/D₁ can be no greater than about 10.0, such as no greater than about 9.0, no greater than about 8.0, no greater than about 7.0, no greater than about 6.0, or even no greater than about 5.0. Moreover, H_{OM}/D₁ can be within a range between and including any of the values described above, such as, for example, between about 2.0 and about 2.5.

In particular embodiments, the annular body 2 can define an annular cavity 22 extending into the annular body 2 radially outward from the central axis 10. The annular cavity 22 can be coaxial to the central axis 10. In a certain aspect, the annular cavity 22 can be contained within a space formed between the inner surface 8 of the outer member 12 and the first and second flanges 18 and 20.

The annular cavity 22 can define a generally rectilinear cross section when viewed in a direction perpendicular to a plane extending radially from the central axis 10. Moreover, the annular cavity can comprise one or more fillets, rounded edges, angular components, or any combination thereof.

The sealing element 4 can be at least partially disposed within the annular body 2. Specifically, the sealing element 4 can be partially disposed within the annular cavity 22 of the annular body 2.

In a particular embodiment, the sealing element 4 can define a first flange 24 and a second flange 26. The first flange 24 of the sealing element 4 can be disposed between the first and second flanges 18 and 20 of the annular body 2. A member 28 can extend between, or join, the first and second flanges 24 and 26.

The first and second flanges 24 and 26 can each extend a length, L₁ and L₂, respectively, as measured from the member 28. In a particular embodiment, L₁ can be equal to L₂ (FIG. 1).

In another embodiment, L₁ can be no less than L₂. For example, L₁/L₂ can be at least about 1.01, such as at least about 1.05, at least about 1.25, at least about 1.50, at least about 1.75, at least about 2.0, at least about 2.25, at least about 2.50, at least about 2.75, or even at least about 3.0. In further embodiments, L₁/L₂ can be no greater than about 6.0, such as no greater than about 5.0, no greater than about 4.0, or even no greater than about 3.5. Moreover, L₁/L₂ can be within a range between and including any of the values described above, such as, for example, between about 1.05 and about 1.25.

In certain embodiments, the sealing element 4 can have a radial width, W_{M}, as measured by a maximum radial distance between the first and second flanges 24 and 26 in the undeformed state. W_{M}/L₂ can be at least about 0.05, such as at least about 0.1, at least about 0.25, at least about 0.5, at least about 0.75, or even at least about 1.0. W_{M}/L₂ can be no greater than about 3.0, such as no greater than about 2.0, no greater than about 1.5, no greater than about 1.25, or even no greater than about 1.05. Moreover, W_{M}/L₂ can be within a range between and including any of the values described above, such as, for example, between about 0.15 and about 0.25.

The first flange 24 can have a relative angle, A₁, as measured against the member 28 in the undeformed state, i.e., prior to engagement of the seal 1 with a shaft. In particular embodiments, A₁ can be greater than about 90 degrees, such as greater than about 100 degrees, greater than about 110 degrees, greater than about 120 degrees, greater than about 130 degrees, or even greater than about 140 degrees. In further embodiments, A₁ can be less than about 180 degrees, such as less than about 170 degrees, less than about 160 degrees, or even less than about 150 degrees. Moreover, A₁ can be within a range between and including any of the values described above, such as, for example, between about 105 degrees and about 115 degrees.

Similarly, the second flange 26 can have a relative angle, A₂, as measured against the member 28 in the undeformed state. In particular embodiments, A₂ can be greater than about 90 degrees, such as greater than about 100 degrees, greater than about 110 degrees, greater than about 120 degrees, greater than about 130 degrees, or even greater than about 140 degrees. In further embodiments, A₂ can be less than about 180 degrees, such as less than about 170 degrees, less than about 160 degrees, or even less than about 150 degrees. Moreover, A₂ can be within a range between and including any of the values described above, such as, for example, between about 105 degrees and about 115 degrees.

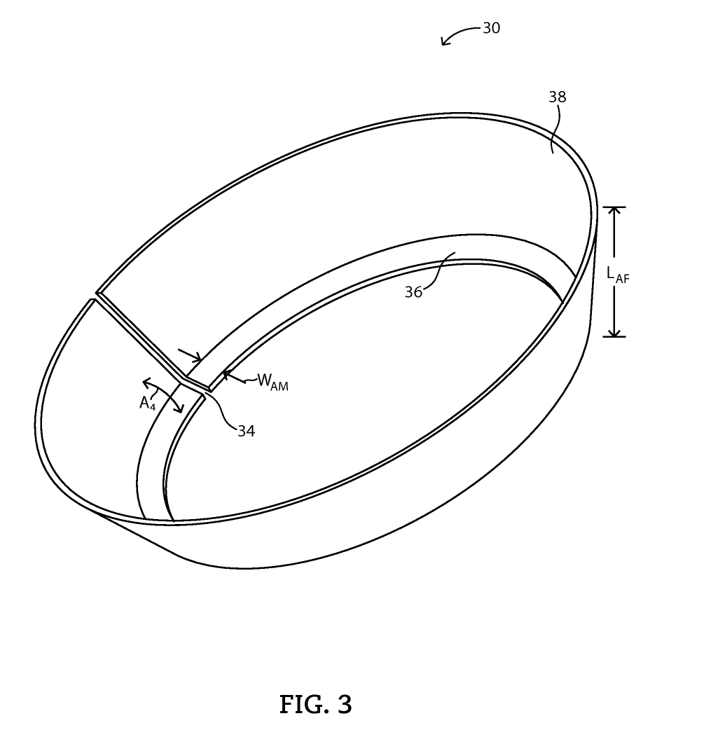

In the undeformed state, angles A₁ and A₂ can be the same or different. Moreover, L₁ and L₂ can be the same or different. In this regard, the sealing element 4 does not require a symmetrical cross section when viewed in a direction perpendicular to a plane extending radially from the central axis 10. For example, referring now to FIG. 2, in particular embodiments, the sealing element 4 can have a segmented, or polygonal, cross-sectional profile.

Referring again to FIG. 1, in a particular embodiment, the sealing element 4 can comprise a generally V-shaped cross section when viewed in a direction perpendicular to a plane extending radially from the central axis 10. The first and second flanges 24 and 26 can form a relative angle, A₃, as measured therebetween in the undeformed state. In a certain aspect, A₃ can be no less than about 20 degrees, such as no less than about 30 degrees, no less than about 40 degrees, no less than about 50 degrees, no less than about 60 degrees, no less than about 70 degrees, no less than about 80 degrees, or even no less than about 90 degrees. In another aspect, A₃ can be no greater than about 150 degrees, such as no greater than about 140 degrees, no greater than about 130 degrees, no greater than about 120 degrees, no greater than about 110 degrees, or even no greater than about 100 degrees. Moreover, A₃ can be within a range between and including any of the values described above, such as, for example, between about 45 degrees and about 55 degrees.

In a certain aspect, the sealing element 4 can be formed from a monolithic construction. In another aspect, the sealing element 4 can be formed from multiple components joined together by any means recognizable in the art, such as, for example, by mechanical deformation (e.g., crimping or splines), adhesive, welding, melting, or any combination thereof.

In particular embodiments, the sealing element 4 can comprise a material having a Modulus of Elasticity (MOE) of no less than about 0.01 gigapascal (GPa), such as no less than about 0.5 GPa, no less than about 0.75 GPa, or even no less than about 1.0 GPa. In further embodiments, the sealing element 4 can comprise a material having an MOE of no greater than about 5.0 GPa, such as no greater than about 4.0 GPa, no greater than about 3.0 GPa, no greater than about 2.0 GPa, or even no greater than about 1.5 GPa. Moreover, the sealing element 4 can comprise a material having an MOE within a range between and including any of the values described above, such as, for example, between about 0.45 and about 1.5.

In certain embodiments, the sealing element 4 can comprise a polymer. For example, the sealing element 4 can comprise materials including a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof. Fluoropolymers are used according to particular embodiments.

In a particular embodiment, the sealing element 4 can comprise a material having a low temperature hard coating, such as, for example, a diamond-like coating (DLC) impregnated therein. In particular embodiments, the DLC can have a lattice structure similar to a diamond, wherein each carbon atom comprises four carbon atoms equally spaced. Alternatively, the sealing element 4 can comprise a material impregnated therein by use of a high velocity oxygen fuel (HVOF) coating. HVOF coatings can extend sealing surface life by significantly increasing the sealing element's resistance to wear and corrosion. Moreover, HVOF coatings can affect a smoother surface finish with bond strengths in excess of approximately 10,000 pounds per square inch.

In a particular aspect, the sealing element 4 can further include one or more fillers, such as graphite, glass, aromatic polyester (EKONOL®), bronze, zinc, boron nitride, carbon, and/or polyimide. Concentrations of each of these fillers in a polymer such as PTFE may be greater than 1%, such as greater than 5%, greater than 10% or even greater than 20% by weight.

In addition, the sealing element 4 can further include lubrication to enhance sliding characteristics against the shaft. Exemplary lubricants can include molybdenum disulfide, tungsten disulfide, graphite, grapheme, expanded graphite, boron nitrade, talc, calcium fluoride, or any combination thereof. Additionally, the lubricant can comprise alumina, silica, titanium dioxide, calcium fluoride, boron nitride, mica, Wollastonite, silicon carbide, silicon nitride, zirconia, carbon black, pigments, or any combination thereof.

Referring to FIG. 2, the sealing element 4 can comprise a thickness, T_{SE}, when viewed in a direction perpendicular to a plane extending radially from the central axis 10. In a particular aspect, T_{SE} can vary or be substantially uniform throughout the sealing element 4.

In particular embodiments, T_{SE} can be no less than about 0.05 inches, such as no less than about 0.10 inches, no less than about 0.15 inches, or even no less than about 0.20 inches. In further embodiments, T_{SE} can be no greater than about 1.5 inches, no greater than about 1.25 inches, no greater than about 1.0 inches, no greater than about 0.75 inches, no greater than about 0.5 inches, or even no greater than about 0.25 inches. Moreover, T_{SE} can be within a range between and including any of the values described above.

In another embodiment, the sealing element 4 can have a total width, W_{SE}, when viewed in a direction perpendicular to a plane extending radially from the central axis 10, i.e., L₁+L₂+W_{M}, and W_{SE}/T_{SE} can be at least about 10, such as at least about 25, at least about 50, at least about 75, at least about 100, at least about 125, at least about 150, or even at least about 200. In further embodiments, W_{SE}/T_{SE} can be no greater than about 1000, such as no greater than about 900, no greater than about 800, no greater than about 700, no greater than about 600, no greater than about 500, no greater than about 400, or even no greater than about 300. Moreover, W_{SE}/T_{SE} can be within a range between and including any of the values described above, such as, for example, between about 30 and about 45.

Referring again to FIGS. 1 to 7, in certain embodiments, the seal 1 can further include a biasing element 30 positioned adjacent the sealing element 4.

In certain embodiments, the sealing element 4 can be disposed between the biasing element 30 and the annular body 2 when viewed in a direction perpendicular to a plane extending radially from the central axis 10. In such a manner, the biasing element 30 can apply an at least partially radial force against at least a portion of the sealing element 4.

In more particular embodiments, the biasing element 30 can be positioned at least partially along an inner surface 32 of the sealing element 4, such as, for example, radially between the first and second flanges 24 and 26 of the sealing element 4. In such a manner, the biasing element 30 can provide a radial biasing force to the first and second flanges 24 and 26 of the sealing element 4.

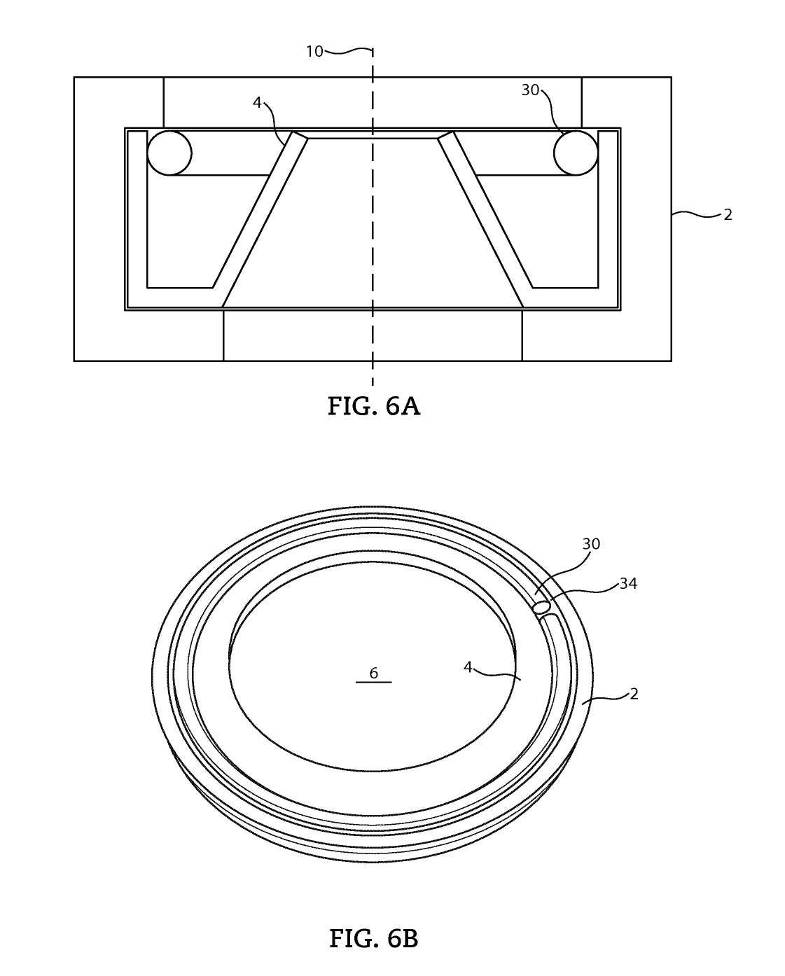

In certain embodiments, the biasing element 30 can comprise a spring adapted to bias at least a portion of the sealing element 4 in a radial, or substantially radial, direction. In more particular embodiments, the biasing element 30 can comprise an annular spring such as, for example, a garter spring (FIG. 6), a rimmed spring (e.g., FIG. 3), or a compression spring (helical spring) bent to form a torus.

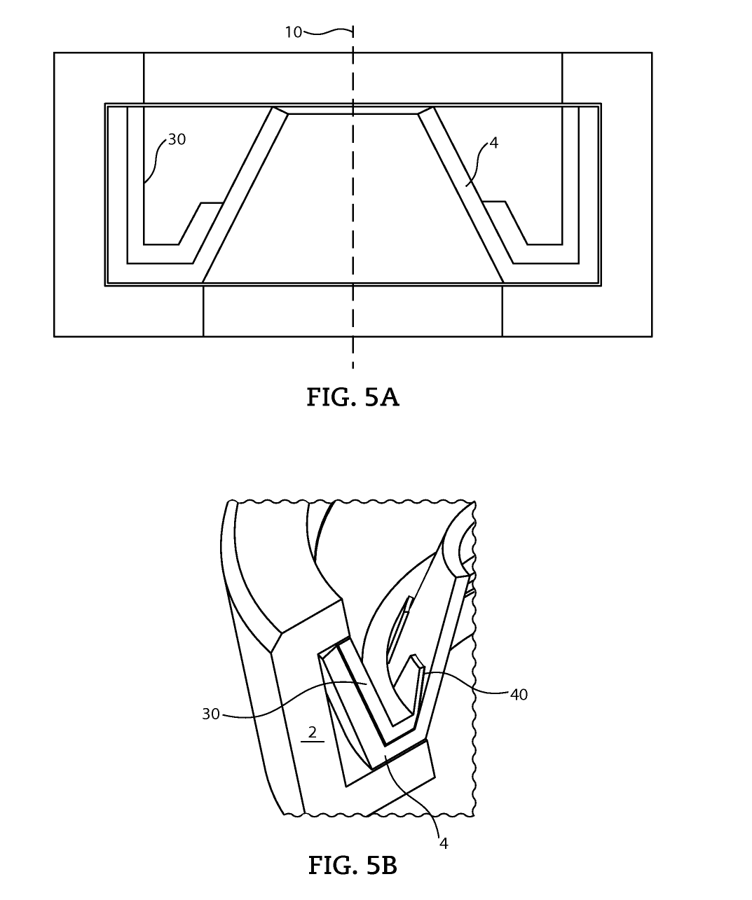

In a non-limiting embodiment, the biasing element 30 can comprise a generally L-shaped cross section when viewed in a direction perpendicular to a plane extending radially from the central axis 10 (FIGS. 2 and 3). In other embodiments, such as illustrated in FIGS. 5A and 5B, the biasing element 30 can comprise any other shape, such as, for example, a generally V-shape, a generally U-shape, a generally C-shape, or any combination thereof.

In certain embodiments, the biasing element 30 can include an axial gap 34 extending at least partially along the axial length thereof. The axial gap 34 can permit easier manufacture and assembly of the seal 1 as compared to a circumferentially continuous biasing element devoid of an axial gap. In certain embodiments, the circumferential edges formed by the axial gap 34 can be secured together to form a continuous body. The circumferential edges can be secured by any known process for joining adjacent bodies, such as, for example, by welding, mechanical deformation (e.g., crimping), adhesive, fasteners (threaded or non-threaded) or any combination thereof.

As illustrated in FIG. 3, the biasing element 30 can comprise an annular member 36 and an annular flange 38 extending from the annular member 36. A relative angle, A₄, can be formed between the annular member 36 and the annular flange 38, as viewed in the undeformed state, i.e., prior to engagement with the sealing element 4. In a particular embodiment, A₄, can be greater than about 90 degrees, such as greater than about 100 degrees, or even greater than about 110 degrees. In further embodiments, A₄ can be less than about 150 degrees, such as less than about 140 degrees, less than about 130 degrees, or even less than about 120 degrees. Moreover, A₄ can be within a range between and including any of the values described above, such as, for example, between about 110 degrees and about 120 degrees.

The annular member 36 of the biasing element 30 can have a radial width, W_{AM}, and the annular flange 38 can have a radial length, L_{AF}, as measured by a distance the annular flange 38 extends from the annular member 36. In certain embodiments, L_{AF}/W_{AM} can be no less than about 1.0, such as no less than about 1.25, no less than about 1.5, no less than about 1.75, or even no less than about 2.0. In other embodiments, L_{AF}/W_{AM} can be no greater than about 10, such as no greater than about 5.0, no greater than about 4.0, no greater than about 3.0, or even no greater than about 2.5. Moreover, L_{AF}/W_{AM} can be within a range between and including any of the values described above, such as, for example, between about 4.0 and about 4.5.

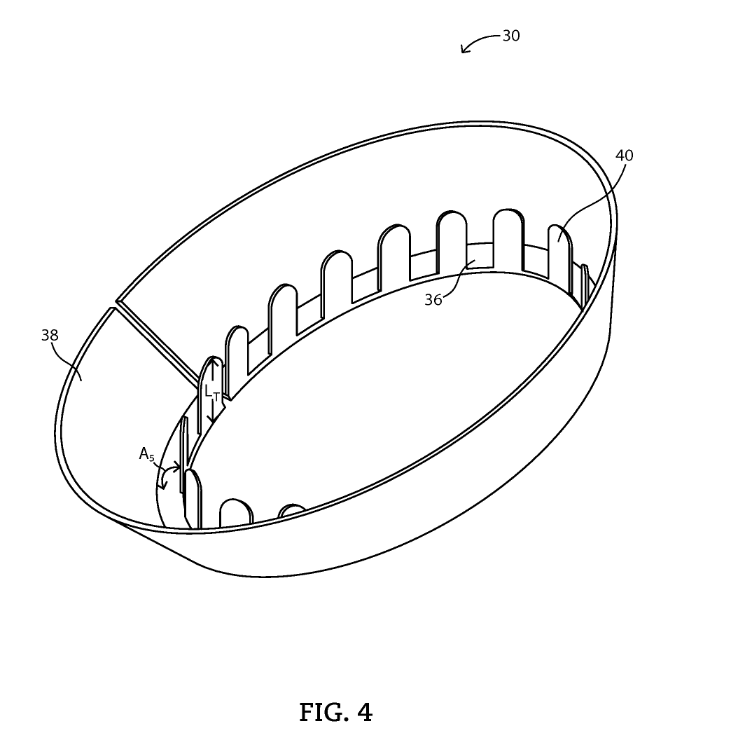

In further embodiments, as shown in FIG. 4, the biasing element 30 can comprise at least one tine 40 extending from the annular member 36 opposite the annular flange 38. The at least one tine 40 can form a relative angle, A₅, relative to the annular member 36. In a particular embodiment, A₅ can be greater than about 90 degrees, such as greater than about 100 degrees, or even greater than about 110 degrees. In a further embodiment, A₅ can be less than about 150 degrees, such as less than about 140 degrees, less than about 130 degrees, or even less than about 120 degrees. Moreover, A₅ can be within a range between and including any of the values described above, such as, for example, between about 110 degrees and about 120 degrees.

The biasing element 30 can alternatively include a plurality of tines 40, such as, for example, at least 2 tines, at least 3 tines, at least 4 tines, at least 5 tines, at least 6 tines, at least 7 tines, at least 8 tines, at least 9 tines, at least 10 tines, at least 20 tines, or even at least 50 tines. In a preferred embodiment, adjacent tines 40 can be spaced evenly circumferentially around the biasing element 30. In another embodiment, adjacent tines 40 can be spaced at varying distances around the circumference of the annular member 36 of the biasing element 30.

Each tine 40 can have a radial length, L_{T}, as measured by a distance the tine 40 extends from the annular member 36. In particular embodiments, L_{AF}/L_{T} can be no less than about 0.75, no less than about 1.0, no less than about 1.25, no less than about 1.5, no less than about 1.75, or even no less than about 2.0. In other embodiments, L_{AF}/L_{T} can be no greater than about 10.0, such as no greater than about 5.0, no greater than about 4.0, no greater than about 3.0, or even no greater than about 2.5. Moreover, L_{AF}/L_{T} can be within a range between and including any of the values described above, such as, for example, between about 4.5 and about 5.5.

In certain embodiments, the biasing element 30 can comprise a material having a Modulus of Elasticity of no less than about 5.0 gigapascals (GPa), such as no less than about 10.0 GPa, no less than about 25.0 GPa, no less than about 50 GPa, no less than about 100 GPa, or even no less than about 150 GPa. In a further embodiment, the biasing element 30 can comprise a material having a Modulus of Elasticity of no greater than about 300 GPa, such as no greater than about 250 GPa, or even no greater than about 225 GPa. Moreover, the biasing element 30 can comprise a material having a Modulus of Elasticity within a range between and including any of the values described above, such as, for example, between about 120 MPa and about 180 MPa.

In a particular aspect, the biasing element 30 can comprise a material having a tensile strength of no less than about 1000 megapascals (MPa), such as no less than about 1200 MPa, or even no less than about 1500 MPa. In a further embodiment, the biasing element 30 can comprise a material having a tensile strength of no greater than about 2500 megaPascals (MPa), such as no greater than about 2000 MPa, or even no greater than about 1800 MPa. Moreover, the biasing element 30 can comprise a material having a tensile strength within a range between and including any of the values described above, such as, for example, between about 1600 MPa and about 1750 MPa.

In another aspect, the biasing element 30 can comprise a material having a coefficient of thermal expansion (CTE) of between approximately 5.0×10⁻⁶ in/in° F. and approximately 15.0×10⁻⁶ in/in° F., such as between approximately 7.0×10⁻⁶ in/in° F. and approximately 12.0×10⁻⁶ in/in° F., between approximately 8.5.0×10⁻⁶ in/in° F. and approximately 11.5×10⁻⁶ in/in° F., or even between approximately 10.0×10⁻⁶ in/in° F. and approximately 10.5×10⁻⁶ in/in° F.

In specific embodiments, the biasing element 30 can comprise a metal. In yet more particular embodiments, the biasing element 30 can comprise a steel, such as a spring steel.

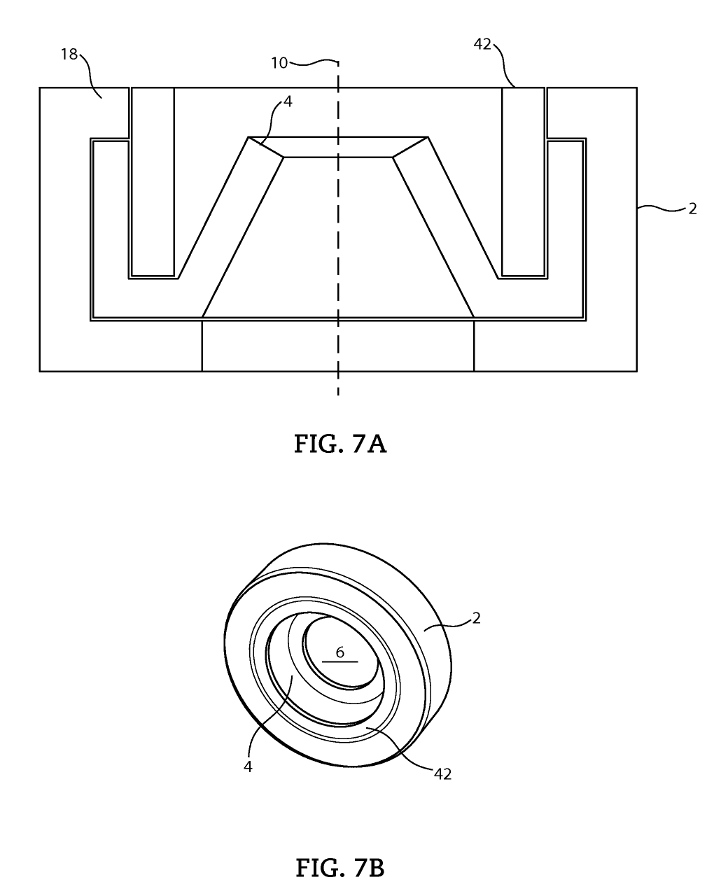

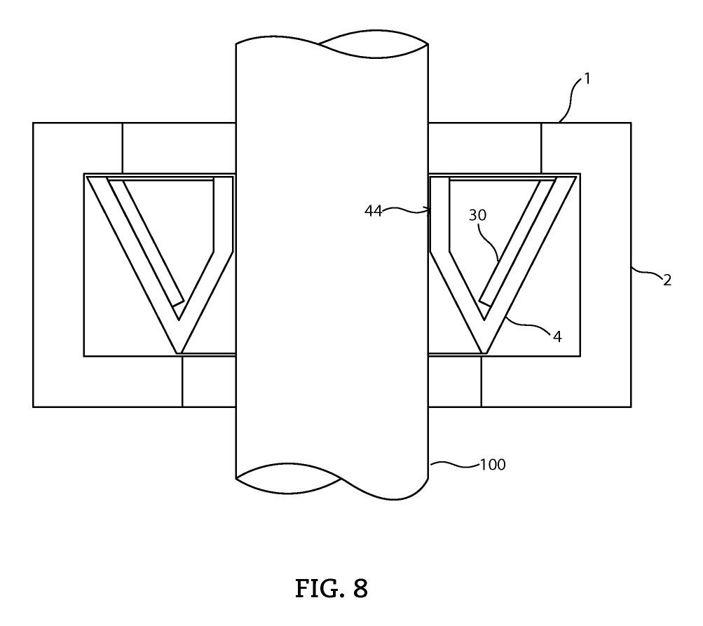

Referring now to FIG. 7, in particular embodiments, the seal 1 can include a press ring 42 retaining the sealing element 4 within the housing 2. The press ring 42 can comprise a generally annular ring. Moreover, the press ring 42 can optionally be attached to the housing 2 at flange 18. For example, the press ring 42 can be attached to the housing 2 by a weld, an adhesive, a spline, a mechanical deformation (e.g., a crimp), or any combination thereof. In an alternate embodiment, the press ring 42 can form an interference fit with the housing 2.

In certain embodiments, during assembly, the press ring 42 can be slid along the central axis 10 of the seal 1 until a top surface of the press ring 42 is flush with a top surface of the housing 2, at which point, the sealing element 4 can be secured. In alternate embodiments, the top surface of the press ring 42 can be below or above the top surface of the housing 2.

FIG. 8 includes a cross-sectional view of a seal 1 engaged around a shaft 100 in accordance with embodiments herein. In such a manner, a portion of the sealing element 4 can form a contact surface 44 with the shaft 100. The sealing element 4 can be biased in the radial direction by the biasing element 30, thereby increasing the force exerted by the contact surface 44 of the sealing element 4 against the shaft 100.

As shown in FIG. 1, the sealing element 4 can have a minimum diameter D_{MIN}, as measured by a smallest distance between diametrically opposite internal sides of the sealing element 4. A person of ordinary skill in the art will understand that the diameter D_{MIN} of the sealing element 4 in a free state, i.e., prior to engagement with the shaft, can be smaller than the diameter of the shaft 100. In such a manner, the seal 1, i.e., the sealing element 4, can form an effective seal against the shaft 100.

In particular embodiments, the biasing element 30, when installed in the seal 1, can be adapted to provide a radial biasing force of at least about 1.0 kilopascal (KPa), such as at least about 5 KPa, at least about 10 KPa, at least about 25 KPa, at least about 50 KPa, at least about 100 KPa, or even at least about 250 KPa. In further embodiments, the biasing element 30 can be adapted to provide a biasing force of no greater than about 500 KPa, such as no greater than about 400 KPa, or even no greater than about 300 KPa. Moreover, the biasing element 30 can be adapted to provide a biasing force within a range between and including any of the values described above, such as, for example, between about 225 KPa and about 275 KPa.

In particular embodiments, the seal 1 can be adapted to receive a shaft 100 having a diameter of no greater than about 50 mm, such as no greater than about 15 mm, no greater than about 10 mm, no greater than about 9 mm, no greater than about 8 mm, no greater than about 7 mm, no greater than about 6 mm, or even no greater than about 5 mm. In other embodiments, the seal 1 can be adapted to receive a shaft having a diameter of between about 51 mm and about 100 mm. In yet further embodiments, the seal 1 can be adapted to receive a shaft having a diameter of greater than 100 mm.

The seal 1 can be adapted to operate within a wide temperature range while simultaneously maintaining effective sealing rates. For example, the seal 1 can be adapted to operate at temperatures within a range between about −275° C. and about 300° C., such as within a range between about −250° C. and about 250° C., within a range between about −100° C. and about 100° C., or even within a range between about −40° C. and about 20° C., while exhibiting a leakage rate of less than about 10 mL/min/mm, such as less than about 9 mL/min/mm, less than about 8 mL/min/mm, less than about 7 mL/min/mm, less than about 6 mL/min/mm, less than about 5 mL/min/mm, less than about 4 mL/min/mm, less than about 3 mL/min/mm, less than about 2 mL/min/mm, less than about 0 mL/min/mm, less than about 0.75 mL/min/mm, less than about 0.5 mL/min/mm, less than about 0.25 mL/min/mm, less than about 0.1 mL/min/mm, or even less than about 0.01 mL/min/mm. Moreover, the seal 1 can be adapted to operate within the above described temperature range while having a leakage rate of about 0 mL/min/mm.

### Examples

Sample 1 is a seal including a housing with a V-shaped sealing element disposed partly within the housing. The sealing element has: a thickness of 0.4 mm; a surface roughness, as measured prior to testing, of 0.1; an elongation, as measured according to ASTM D1708, of 150%; and a tensile strength, as measured according to ASTM D1708, of 17.2 MPa. The seal of Sample 1 is devoid of an internal biasing element.

Sample 2 is a seal including a housing, a V-shaped sealing element disposed partly within the housing, and a biasing element having an L-shape and biasing the sealing element in a generally radial direction in accordance with an embodiment herein. The sealing element has: a thickness of 0.4 mm; a surface roughness, as measured prior to testing, of 0.1; an elongation, as measured according to ASTM D638, of 450%; and a tensile strength, as measured according to ASTM D638, of 26.9 MPa.

A static test is first conducted using a cylindrical shaft inserted into an outer component having a bore. Each seal is inserted into the annular space between the shaft and bore. The samples are maintained at room temperature (approximately 23° C.) and the leakage rate is recorded. Samples 1 and 2 are cycled between −40° C. and 160° C. at a predefined rate and the leakage rate is recorded with the shaft stationary relative to the seal and the bore of the outer component. The test is repeated three times and the mean leakage rate is calculated for both Samples 1 and 2.

TABLE 1
Sample 1 Test Data

| Temper- | Minimum Leakage | Maximum Leakage | Mean Leakage |
|---|---|---|---|
| ature | Rate (mL/min) | Rate (mL/min) | Rate (mL/min) |
| 25° C. | 0.00 | 31.79 | 24.12 |
| 160° C. | 10.56 | 11.70 | 11.03 |
| 25° C. | 14.29 | 19.32 | 18.30 |
| −40° C. | 32.62 | 35.10 | 33.85 |
| 25° C. | 20.53 | 24.48 | 22.79 |

TABLE 2
Sample 2 Test Data

| Temper- | Minimum Leakage | Maximum Leakage | Mean Leakage |
|---|---|---|---|
| ature | Rate (mL/min) | Rate (mL/min) | Rate (mL/min) |
| 25° C. | 0.00 | 7.44 | 6.61 |
| 160° C. | 6.20 | 7.04 | 6.65 |
| 25° C. | 6.78 | 9.06 | 8.02 |
| −40° C. | 17.16 | 20.37 | 18.94 |
| 25° C. | 7.55 | 8.50 | 9.95 |

As illustrated in Tables 1 and 2, Sample 2 has an average mean leakage rate, as measured throughout the complete temperature cycle, of approximately 10 mL/min while Sample 1 has an average mean leakage rate of approximately 22 mL/min. Thus, Sample 2 exhibits an average mean leakage rate of approximately 45% as compared to the average mean leakage rate of Sample 1.

The seals are then tested using a reciprocating cylindrical shaft inserted into an outer component having a bore. Each seal is inserted into the annular space between the shaft and bore. The samples are maintained at room temperature (approximately 23° C.) and the leakage rate is recorded with the shaft reciprocating at 1 linear cycle per second (one cycle includes one full linear movement of the shaft within the bore). The seals each undergo six stages of testing conditions. In stage 1, the system has a pressure of 0.00 mbar, i.e., there is no pressure gradient between sides of the seal, and 200,000 cycles are run. In stage 2, the system has a pressure of 1,000 mbar, i.e., a pressure gradient of 1,000 mbar exists, and 800,000 cycles are run. In stage 3, the system has a pressure of 2,000 mbar and 500,000 cycles are run. In stage 4, the system has a pressure of 2,000 mbar and 1,000,000 cycles are run. In stage 5, the system has a pressure of 2,000 mbar and 2,000,000 are run. In stage 6, the system has a pressure of 3,000 mbar and 500,000 cycles are run.

TABLE 3
Samples 1 and 2 Test Data

| | Stage 1 | Stage 2 | Stage 3 | Stage 4 | Stage 5 | Stage 6 |
|---|---|---|---|---|---|---|
| Sample | (L/min) | (L/min) | (L/min) | (L/min) | (L/min) | (L/min) |
| 1 | 0.003 | 0.000 | 0.220 | 0.000 | 0.002 | 0.003 |
| 2 | 0.001 | 0.000 | 0.000 | 0.000 | 0.000 | 0.002 |

As illustrated in Table 3, Sample 2 had an equal or lower leakage rate during all six stages of testing upon exposure to a shaft reciprocating at 1 linear cycle per second.

Items.

Item 1. A rotary shaft seal comprising:
an annular body having an aperture defining a central axis and an inner surface;
a sealing element positioned at least partially within the annular body, wherein the sealing element is configured to extend radially and form a seal between the annular body and a shaft disposed within the aperture of the annular body; and
a biasing element biasing at least a portion of the sealing element in a radial direction.

Item 2. A rotary shaft seal comprising:
an annular body defining a central axis, wherein the annular body has a retaining element;
a sealing element disposed at least partially within the annular body; and
a biasing element biasing at least a portion of the flanged sealing element in a radial direction.

Item 3. A rotary shaft seal comprising:
an annular body defining a central axis, wherein the annular body has a generally C-shaped cross section when viewed in a direction perpendicular to a plane extending radially from the central axis; and
a sealing element disposed at least partially within the annular body, wherein the sealing element has a generally U-shaped cross section when viewed in a direction perpendicular to a plane extending radially from the central axis.

Item 4. The rotary shaft seal according to any one of items 2 or 3, wherein the body defines an aperture coaxial with the central axis.

Item 5. The rotary shaft seal according to any one of items 3 or 4, wherein the rotary shaft seal is adapted to receive a shaft through the aperture, the shaft having a diameter of no greater than about 50 mm, no greater than about 15 mm, no greater than about 10 mm, no greater than about 9 mm, no greater than about 8 mm, no greater than about 7 mm, no greater than about 6 mm, or no greater than about 5 mm.

Item 6. The rotary shaft seal according to any one of the preceding items, wherein the rotary shaft seal is adapted to operate at temperatures within a range between about −275° C. and about 300° C., between about −250° C. and about 250° C., between about −100° C. and about 100° C., or between about −40° C. and about 20° C.

Item 7. The rotary shaft seal according to item 1, wherein the annular body has a generally C-shaped cross section when viewed in a direction perpendicular to a plane extending radially from the central axis.

Item 8. The rotary shaft seal according to any one of the preceding items, wherein the annular body defines an outer member having a first end and a second end, a first flange disposed proximate the first end of the outer member and extending radially inward from the outer member, and a second flange disposed proximate the second end of the outer member and extending radially inward from the outer member.

Item 9. The rotary shaft seal according to item 8, wherein the first flange extends a radial distance, D₁, as measured from the outer member, wherein the second flange extends a radial distance, D₂, as measured from the outer member, and wherein D₁ is no less than D₂.

Item 10. The rotary shaft seal according to item 9, wherein D₁/D₂ is at least about 1.01, at least about 1.05, at least about 1.25, at least about 1.50, at least about 1.75, at least about 2.0, at least about 2.25, at least about 2.50, at least about 2.75, or at least about 3.0.

Item 11. The rotary shaft seal according to any one of items 8 or 9, wherein D₁/D₂ is no greater than about 6.0, no greater than about 5.0, no greater than about 4.0, or no greater than about 3.5.

Item 12. The rotary shaft seal according to any one of items 9-11, wherein the outer member has a height, H_{OM}, and wherein H_{OM}/D₂ is at least about 0.5, at least about 0.75, at least about 1.0, at least about 1.25, at least about 1.5, or at least about 2.0.

Item 13. The rotary shaft seal according to item 12, wherein H_{OM}/D₂ is no greater than about 8.0, no greater than about 7.0, no greater than about 6.0, no greater than about 5.0, no greater than about 4.0, or no greater than about 3.0.

Item 14. The rotary shaft seal according to any one of the preceding items, wherein the annular body defines an annular cavity concentric to the central axis of the aperture and extending outward from the central axis and into the annular body.

Item 15. The rotary shaft seal according to item 14, wherein the sealing element is disposed at least partially within the annular cavity.

Item 16. The rotary shaft seal according to any one of the preceding items, wherein the annular body comprises a material having a Brinell hardness (HB) in a range of about 70 to about 150, in a range of about 75 to about 145, in a range of about 80 to about 140, in a range of about 85 to about 135, in a range of about 90 to about 130, in a range of about 95 to about 125, in a range of about 100 to about 120, or in a range of about 105 to about 115.

Item 17. The rotary shaft seal according to any one of the preceding items, wherein the annular body comprises a material having a tensile strength of at least about 350 megapascal (MPa), at least about 360 MPa, at least about 370 MPa, at least about 380 MPa, at least about 390 MPa, at least about 400 MPa, or at least about 410 MPa.

Item 18. The rotary shaft seal according to any one of the preceding items, wherein the annular body comprises a material having a tensile strength of no greater than about 5000 MPa, no greater than about 4000 MPa, no greater than about 2000 MPa, no greater than about 1000 MPa, or no greater than about 500 MPa.

Item 19. The rotary shaft seal according to any one of the preceding items, wherein the annular body comprises a copper-zinc alloy.

Item 20. The rotary shaft seal according to item 19, wherein the annular body further comprises lead.

Item 21. The rotary shaft seal according to any one of items 1, 2, or 4-20, wherein the sealing element has a generally U-shaped cross section when viewed in a direction perpendicular to a plane extending radially from the central axis.

Item 22. The rotary shaft seal according to any one of the preceding items, wherein the sealing element defines an member having a first end and a second end, a first flange disposed proximate the first end of the member and extending at least partially radially inward from the member, and a second flange disposed proximate the second end of the member and extending at least partially radially inward from the member.

Item 23. The rotary shaft seal according to item 22, wherein the first flange extends a radial distance, D₁, as measured from the outer member, wherein the second flange extends a radial distance, D₂, as measured from the outer member, and wherein D₁ is no less than D₂.

Item 24. The rotary shaft seal according to item 23, wherein D₁/D₂ is at least about 1.01, at least about 1.05, at least about 1.25, at least about 1.50, at least about 1.75, at least about 2.0, at least about 2.25, at least about 2.50, at least about 2.75, or at least about 3.0.

Item 25. The rotary shaft seal according to any one of items 23 or 24, wherein D₁/D₂ is no greater than about 6.0, no greater than about 5.0, no greater than about 4.0, or no greater than about 3.5.

Item 26. The rotary shaft seal according to any one of items 23-25, wherein the outer member has a width, W_{M}, and wherein W_{M}/D₂ is at least about 0.05, at least about 0.1, at least about 0.25, at least about 0.5, at least about 0.75, or at least about 1.0.

Item 27. The rotary shaft seal according to item 26, wherein W_{M}/D₂ is no greater than about 3.0, no greater than about 2.0, no greater than about 1.5, no greater than about 1.25, or no greater than about 1.05.

Item 28. The rotary shaft seal according to any one of items 22-27, wherein the first flange forms a relative angle, A₁, with the outer member as measured in the undeformed state, and wherein A₁ is greater than about 90 degrees, greater than about 100 degrees, greater than about 110 degrees, greater than about 120 degrees, greater than about 130 degrees, or greater than about 140 degrees.

Item 29. The rotary shaft seal according to item 28, wherein A₁ is less than about 180 degrees, less than about 170 degrees, less than about 160 degrees, or less than about 150 degrees.

Item 30. The rotary shaft seal according to any one of items 22-29, wherein the second flange forms a relative angle, A₂, with the outer member as measured in the undeformed state, and wherein A₂ is at least about 90 degrees, at least about 100 degrees, at least about 110 degrees, at least about 120 degrees, at least about 130 degrees, or at least about 140 degrees.

Item 31. The rotary shaft seal according to item 30, wherein A₂ is less than about 180 degrees, less than about 170 degrees, less than about 160 degrees, or less than about 150 degrees.

Item 32. The rotary shaft seal according to any one of the preceding items, wherein the sealing element comprises a generally V-shaped cross section when viewed in a direction perpendicular to a plane extending radially from the central axis.

Item 33. The rotary shaft seal according to item 32, wherein the sealing element comprises a first flange and a second flange having a relative angle, A₃, as measured therebetween in the undeformed state, and wherein A₃ is no less than about 20 degrees, no less than about 30 degrees, no less than about 40 degrees, no less than about 50 degrees, no less than about 60 degrees, no less than about 70 degrees, no less than about 80 degrees, or no less than about 90 degrees.

Item 34. The rotary shaft seal according to item 33, wherein A₃ is no greater than about 150 degrees, no greater than about 140 degrees, no greater than about 130 degrees, no greater than about 120 degrees, no greater than about 110 degrees, or no greater than about 100 degrees.

Item 35. The rotary shaft seal according to any one of the preceding items, wherein the sealing element comprises a material having a Modulus of Elasticity (MOE) of no less than about 0.05 gigaPascal (GPa), no less than about 0.5 GPa, no less than about 0.75 GPa, or no less than about 1.0 GPa.

Item 36. The rotary shaft seal according to item 35, wherein the sealing element comprises a material having an MOE of no greater than about 5.0 Gpa, no greater than about 4.0 GPa, no greater than about 3.0 Gpa, no greater than about 2.0 GPa, or no greater than about 1.5 GPa.

Item 37. The rotary shaft seal according to any one of the preceding items, wherein the sealing element comprises a polymer.

Item 38. The rotary shaft seal according to any one of the preceding items, wherein the sealing element comprises a fluoropolymer, such as polytetrafluoroethylene (PTFE).

Item 39. The rotary shaft seal according to any one of the preceding items, wherein the sealing element comprises a polyaryletherketone (PEAK), such as Polyether ether ketone (PEEK).

Item 40. The rotary shaft seal according to any one of the preceding items, wherein the sealing element comprises a monolithic piece.

Item 41. The rotary shaft seal according to any one of the preceding items, wherein the sealing element comprises an average thickness, T_{SE}, when viewed in a direction perpendicular to a plane extending radially from the central axis, and wherein T_{SE} is no less than about 0.05 inches, no less than about 0.10 inches, no less than about 0.15 inches, or no less than about 0.20 inches.

Item 42. The rotary shaft seal according to item 41, wherein T_{SE} is no greater than about 0.75 inches, no greater than about 0.50 inches, or no greater than about 0.25 inches.

Item 43. The rotary shaft seal according to item 3, wherein the rotary shaft seal further comprises a biasing element biasing at least a portion of the sealing element in a radial direction.

Item 44. The rotary shaft seal according to any one of items 1, 2, or 4-43, wherein the sealing element is positioned between the biasing element and the annular body when viewed in a direction perpendicular to a plane extending radially from the central axis.

Item 45. The rotary shaft seal according to any one of items 1, 2, or 4-44, wherein the biasing element comprises a spring.

Item 46. The rotary shaft seal according to any one of items 1, 2, or 4-45, wherein the biasing element comprises a generally L-shape when viewed in a direction perpendicular to a plane extending radially from the central axis.

Item 47. The rotary shaft seal according to item 46, wherein the biasing element comprises an annular member and an annular flange extending from the annular member, wherein a relative angle, A₄, is formed between the annular member and the annular flange, and wherein A₄ is greater than about 90 degrees, greater than about 100 degrees, or greater than about 110 degrees.

Item 48. The rotary shaft seal according to item 47, wherein A₄ is less than about 150 degrees, less than about 140 degrees, less than about 130 degrees, or less than about 120 degrees.

Item 49. The rotary shaft seal according to any one of items 47 or 48, wherein the annular member has a radial width, W_{AM}, wherein the annular flange has a radial length, L_{AF}, and wherein L_{AF}/W_{AM} is no less than about 1.0, no less than about 1.25, no less than about 1.5, no less than about 1.75, or no less than about 2.0.

Item 50. The rotary shaft seal according to item 49, wherein L_{AF}/W_{AM} is no greater than about 10.0, no greater than about 5.0, no greater than about 4.0, no greater than about 3.0, or no greater than about 2.5.

Item 51. The rotary shaft seal according to any one of items 46-50, wherein the biasing element further comprises at least one tine extending from the annular member opposite the annular flange, the at least one tine having a relative angle, A₅, as measured between the at least one tine and the annular member, and wherein A₅ is greater than about 90 degrees, greater than about 100 degrees, or greater than about 110 degrees.

Item 52. The rotary shaft seal according to item 51, wherein A₅ is less than about 150 degrees, less than about 140 degrees, less than about 130 degrees, or less than about 120 degrees.

Item 53. The rotary shaft seal according to any one of items 51 or 52, wherein the at least one tine comprises at least 2 tines, at least 3 tines, at least 4 tines, at least 5 tines, at least 10 tines, at least 20 tines, or at least 50 tines.

Item 54. The rotary shaft seal according to items 51-53, wherein the tines are equally spaced apart around the annular member.

Item 55. The rotary shaft seal according to any one of items 51-54, wherein the at least one tine has a radial length, L_{T}, and wherein L_{AF}/L_{T} is no less than about 0.75, no less than about 1.0, no less than about 1.25, no less than about 1.5, no less than about 1.75, or no less than about 2.0.

Item 56. The rotary shaft seal according to item 55, wherein L_{AF}/L_{T} is no greater than about 10, no greater than about 5.0, no greater than about 4.0, no greater than about 3.0, or no greater than about 2.5.

Item 57. The rotary shaft seal according to any one of items 1, 2, or 4-44, wherein the biasing element comprises an annular spring disposed along an inner surface of the sealing element.

Item 58. The rotary shaft seal according to item 57, wherein the biasing element comprises a garter spring.

Item 59. The rotary shaft seal according to item 57, wherein the biasing element comprises a compression spring.

Item 60. The rotary shaft seal according to any one of items 57-59, wherein the biasing element further comprises an axial gap.

Item 61. The rotary shaft seal according to any one of items 57-60, wherein the biasing element is disposed radially inside of an outer flange of the sealing element.

Item 62. The rotary shaft seal according to any one of items 1, 2, or 6-61, wherein the biasing element comprises a material having a Modulus of Elasticity of no less than about 5.0 gigaPascal (GPa), no less than about 10.0 GPa, no less than about 25.0 GPa, no less than about 50 GPa, no less than about 100 GPa, or no less than about 150 GPa.

Item 63. The rotary shaft seal according to any one of items 1, 2, or 6-62, wherein the biasing element comprises a material having a Modulus of Elasticity of no greater than about 300 GPa, no greater than about 250 GPa, or no greater than about 225 GPa.

Item 64. The rotary shaft seal according to any one of items 1, 2, or 6-63, wherein the biasing element comprises a material having a tensile strength of no less than about 1000 megaPascals (MPa), no less than about 1200 MPa, or no less than about 1500 MPa.

Item 65. The rotary shaft seal according to any one of items 1, 2, or 6-64, wherein the biasing element comprises a material having a tensile strength of no greater than about 2500 megaPascals (MPa), no greater than about 2000 MPa, or no greater than about 1800 MPa.

Item 66. The rotary shaft seal according to any one of items 1, 2, or 6-65, wherein the biasing element, when assembled within the rotary shaft seal, provides a biasing force of at least about 1.0 kilopascals (KPa), at least about 5 KPa, at least about 10 KPa, at least about 25 KPa, at least about 50 KPa, at least about 100 KPa, or at least about 250 KPa.

Item 67. The rotary shaft seal according to any one of items 1, 2, or 6-66, wherein the biasing element, when assembled within the rotary shaft seal, provides a biasing force of no greater than about 500 KPa, no greater than about 400 KPa, or no greater than about 300 KPa.

Item 68. The rotary shaft seal according to any one of items 1, 2, or 4-67, wherein the biasing element comprises a metal.

Item 69. The rotary shaft seal according to any one of items 1, 2, or 4-68, wherein the biasing element comprises spring steel.

Item 70. The rotary shaft seal according to any one of the preceding items, wherein the rotary shaft seal has a leakage rate, as measured at a system pressure of 3000 mbar at room temperature for 500,000 cycles, of no greater than about 15 mL/min, such as no greater than about 14 mL/min, no greater than about 13 mL/min, no greater than about 12 mL/min, no greater than about 11 mL/min, no greater than about 10 mL/min, no greater than about 5 mL/min, or no greater than about 2 mL/min.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A rotary shaft seal comprising:
an annular body having an aperture defining a central axis and an inner surface;
a sealing element positioned at least partially within the annular body, wherein the sealing element is configured to extend radially and form a seal between the annular body and a shaft disposed within the aperture of the annular body; and
a biasing element biasing at least a portion of the sealing element in a radial direction.

2. The rotary shaft seal according to claim 1, wherein the annular body has a generally C-shaped cross-sectional profile.

3. The rotary shaft seal according to claim 1, wherein the annular body defines an annular cavity concentric to the central axis of the aperture and extending outward from the central axis into the annular body, and wherein the sealing element is disposed at least partially within the annular cavity.

4. The rotary shaft seal according to claim 1, wherein the annular body defines an outer member having a first end and a second end, a first flange disposed proximate the first end of the outer member and extending radially inward from the outer member, and a second flange disposed proximate the second end of the outer member and extending radially inward from the outer member.

5. The rotary shaft seal according to claim 4, wherein the first flange extends a radial distance, D₁, as measured from the outer member, wherein the second flange extends a radial distance, D₂, as measured from the outer member, and wherein D₁/D₂ is at least 1.05.

6. The rotary shaft seal according to claim 1, wherein the sealing element has a generally V-shaped cross-sectional profile.

7. The rotary shaft seal according to claim 1, wherein the sealing element is positioned between the biasing element and the annular body.

8. The rotary shaft seal according to claim 1, wherein the biasing element has a generally L-shaped cross-sectional profile.

9. The rotary shaft seal according to claim 1, wherein the rotary shaft seal has a leakage rate, as measured at a system pressure of 3000 mbar at room temperature for 500,000 cycles, of no greater than 15 mL/min.

10. A rotary shaft seal comprising:
an annular body defining a central axis, wherein the annular body has a retaining element;
a sealing element disposed at least partially within the annular body; and
a biasing element biasing at least a portion of the flanged sealing element in a radial direction.

11. The rotary shaft seal according to claim 10, wherein the biasing element has a generally L-shaped cross-sectional profile.

12. The rotary shaft seal according to claim 10, wherein the annular body defines an outer member having a first end and a second end, a first flange disposed proximate the first end of the outer member and extending radially inward from the outer member, and a second flange disposed proximate the second end of the outer member and extending radially inward from the outer member, wherein the first flange extends a radial distance, D₁, as measured from the outer member, wherein the second flange extends a radial distance, D₂, as measured from the outer member, and wherein D₁/D₂ is at least 1.05.

13. The rotary shaft seal according to claim 10, wherein the annular body defines an annular cavity concentric to the central axis of the aperture and extending outward from the central axis and into the annular body, and wherein the sealing element is disposed at least partially within the annular cavity.

14. The rotary shaft seal according to claim 10, wherein the sealing element is positioned between the biasing element and the annular body.

15. The rotary shaft seal according to claim 10, wherein the annular body defines an aperture coaxial with the central axis, and wherein the rotary shaft seal is adapted to receive a shaft through the aperture, the shaft having a diameter of no greater than 10 mm.

16. A rotary shaft seal comprising:
an annular body defining a central axis, wherein the annular body has a generally C-shaped cross-sectional profile; and
a sealing element disposed at least partially within the annular body, wherein the sealing element has a generally U-shaped cross-sectional profile.

17. The rotary shaft seal according to claim 16, wherein:
the annular body defines an outer member having a first end and a second end, a first flange disposed proximate the first end of the outer member and extending radially inward from the outer member, and a second flange disposed proximate the second end of the outer member and extending radially inward from the outer member,
the first flange extends a radial distance, D₁, as measured from the outer member, wherein the second flange extends a radial distance, D₂, as measured from the outer member, and
D₁/D₂ is at least about 1.05.

18. The rotary shaft seal according to claim 16, wherein the annular body defines an annular cavity concentric to the central axis of the aperture and extending outward from the central axis and into the annular body, and wherein the sealing element is disposed at least partially within the annular cavity.

19. The rotary shaft seal according to claim 16, wherein the rotary shaft seal further comprises a biasing element biasing at least a portion of the sealing element in a radial direction, and wherein the sealing element is positioned between the biasing element and the annular body.

20. The rotary shaft seal according to claim 19, wherein the biasing element has a generally L-shaped cross-sectional profile.
